(19) United States
(12) Patent Application Publication
(10) Pub. No.: US 2008/0272833 A1
(43) Pub. Date: Nov. 6, 2008

(54) Charge Pump

(76) Inventors: Vadim V. Ivanov, Tucson, AZ (US); Johannes Gerber, Unterschleissheim (DE); Frank Vanselow, Freising (DE)

Correspondence Address: TEXAS INSTRUMENTS INCORPORATED, P O BOX 655474, M/S 3999, DALLAS, TX, 75265, US

(21) Appl. No.: 12/114,283

(22) Filed: May 2, 2008

(30) Foreign Application Priority Data
May 4, 2007 (DE) 10 2007 020 999.3

(51) Int. Cl. G05F 1/10

(52) U.S. Cl. 327/536

(57) ABSTRACT

A charge pump for generating an input voltage for an operational amplifier includes a storage capacitor for storing a charge pump voltage and a flying capacitor configured to be charged during a first phase of operation and discharged during a second phase of operation. Discharging the flying capacitor charges the storage capacitor. A current source supplies the flying capacitor and a switching means switches current from the current source through the flying capacitor in a first direction during the first phase and in a second opposite direction during the second phase.

### CLAIM OF PRIORITY

This application claims priority under 35 U.S.C. 119(e)(1) to U.S. Provisional Application No. 6/016,676 filed Dec. 26, 2007 and under 35 U.S.C. 119(a) to German Patent Application No. 10 2007 020 999.3 filed May 4, 2007.

### TECHNICAL FIELD OF THE INVENTION

The technical field of this invention is a charge pump used to generate voltages above the power supply voltage.

### BACKGROUND OF THE INVENTION

A truly rail to rail input operational amplifier with a PMOS or PMP input stage requires a bootstrap or charge pump voltage above the supply voltage. Any noise and ripples of the charge pump voltage especially at high frequencies leak to the operational amplifier output due to a mismatch of input devices, such as parasitic capacitance etc.

FIGS. 1A and 1B are simplified schematics of a conventional charge pump circuit. The negative terminal of capacitor C1 is switched between a positive supply voltage rail VDD and ground and the positive terminal is switched between the positive supply voltage and a charge pump voltage rail. Storage capacitor C2 is connected to the charge pump voltage rail and the positive supply voltage. During phase1 illustrated in FIG. 1A, capacitor C1 is connected between the supply voltage and ground and charged to the supply voltage. During phase2 illustrated in FIG. 1B, the positive terminal of capacitor C1 is disconnected from the positive supply voltage rail and reconnected to capacitor C2 and the negative terminal of capacitor C1 is disconnected from ground and connected to the supply voltage rail VDD. This results in twice the supply voltage at the positive terminal of capacitor C1. This voltage is used to charge storage capacitor C2 to a voltage equal to 2VDD. For this reason, such a known capacitor is often called a voltage doubler.

FIG. 2 illustrates the output voltage of and current consumed by the conventional charge pump of FIG. 1. The output voltage is a sawtooth. This sawtooth voltage ripple contains high frequency harmonics of the running frequency of relatively large amplitude. These harmonics produce unwanted noise at the output of the charge pump. In addition to the output voltage ripple, the conventional charge pump creates significant power supply noise. The current consumed by the charge pump circuit from the power supply (current I_{q} illustrated in FIG. 2) consists of large amplitude current pulses when the circuit switches from the first phase to the second phase. The value of these current pulses is limited only by the switch resistance. Current pulses create supply voltage ripples due to the bus resistance and wirebond inductance. These current pulses increase the high-frequency noise of the operational amplifier.

### SUMMARY OF THE INVENTION

It is an object of the present invention to provide a charge pump voltage source for use with rail to rail operational amplifier tail current sources that has a low ripple.

The present invention is a charge pump generating a bootstrap voltage, in particular the bootstrap voltage for the tail current of an input stage of an operational amplifier. The charge pump comprises a storage capacitor storing a charge pump voltage and a flying capacitor configured to be charged during a first phase of operation and discharged during a second phase of operation so as to charge the storage capacitor. A current source is coupled to the flying capacitor and a switching means is provided for switching current from the current source through the flying capacitor in a first direction during the first phase and in a second direction opposite during the second phase. Switching current from a current source to charge the flying capacitor in the first phase of operation and to discharge the flying capacitor in the second phase of operation determines the current flowing to and from the flying capacitor. The present invention provides a charge pump voltage that is smoother with a more symmetric and more triangular waveform than the sawtooth output voltage produced by the conventional voltage doubler. This produces less high-frequency content and consequently a reduced high frequency noise in the operational amplifier in which the charge pump is used.

Furthermore, the output voltage level can be controlled by configuring the current source, which can be a variable current source, to provide the right level of current for charging the flying capacitor to the required voltage. Therefore the charge pump output voltage can be tailored to any voltage up to twice the input voltage. If an output voltage twice the supply voltage provided by a conventional voltage-doubling charge pump is too high for a particular application, the voltage can be set to the required level by control of the current source. Providing a current source for charging the flying capacitor also results in the charge pump without large amplitude switching pulses. This generates less noise in the supply bus.

The charge pump according to the present invention preferably includes a control loop with an error amplifier. The error amplifier compares the output voltage with a reference voltage. The error amplifier generates a control signal coupled to control the variable current source based on the difference between the output voltage of the charge pump and the reference voltage. This controls the amount of charging current of the flying capacitor and the output voltage level. The desired output voltage of the charge pump can be set by selection of the reference current source providing the appropriate reference voltage and the capacitance of the flying capacitor. The output voltage can be set in a feedback operation. For example, the charge pump output voltage can be compared with the reference voltage. If the output voltage deviates from the reference voltage, the current supplied by the current source is adjusted. The value of the current becomes equal to two times the load current of the charge pump and the output voltage becomes equal to the voltage level defined by the reference voltage. The reference voltage is set to be equal to the desired output voltage.

If the time constant of the control loop is substantially greater than a period of the switching sequence of the switching means, the current drawn from the current source is substantially constant. Charging and discharging the flying capacitor using a constant current means that the current drawn by the charge pump is constant. This reduces voltage ripples in the power supply.

The charge pump preferably comprises a controller controlling the switching means. The switching means preferably comprises a first switching path for switching current through the flying capacitor in a first direction and a second switching path for switching current through the flying capacitor in a second direction. The second switching path can be controlled by a single control port in the controller. This reduces the complexity of the charge pump circuit. The controller provides a feedback mechanism to the switching arrangement, so that when the storage capacitor has been charged to the required charge pump voltage by the flying capacitor, the current source can be immediately switched to start charging the flying capacitor again.

### BRIEF DESCRIPTION OF THE DRAWINGS

These and other aspects of this invention are illustrated in the drawings, in which:

FIG. 1A is a simplified schematic diagram of a conventional charge pump in a first phase of operation;

FIG. 1B is a simplified schematic diagram of a conventional charge pump in a first phase of operation;

FIG. 2 illustrates graphs of output voltage against time and supply current against time in a conventional charge pump;

FIG. 3 is a simplified schematic diagram of a charge pump according to a first embodiment the present invention;

FIG. 4 illustrates graphs of output voltage against time and supply current against time in a charge pump according to this invention; and

FIG. 5 is a simplified schematic diagram of a charge pump according to a second embodiment of this invention.

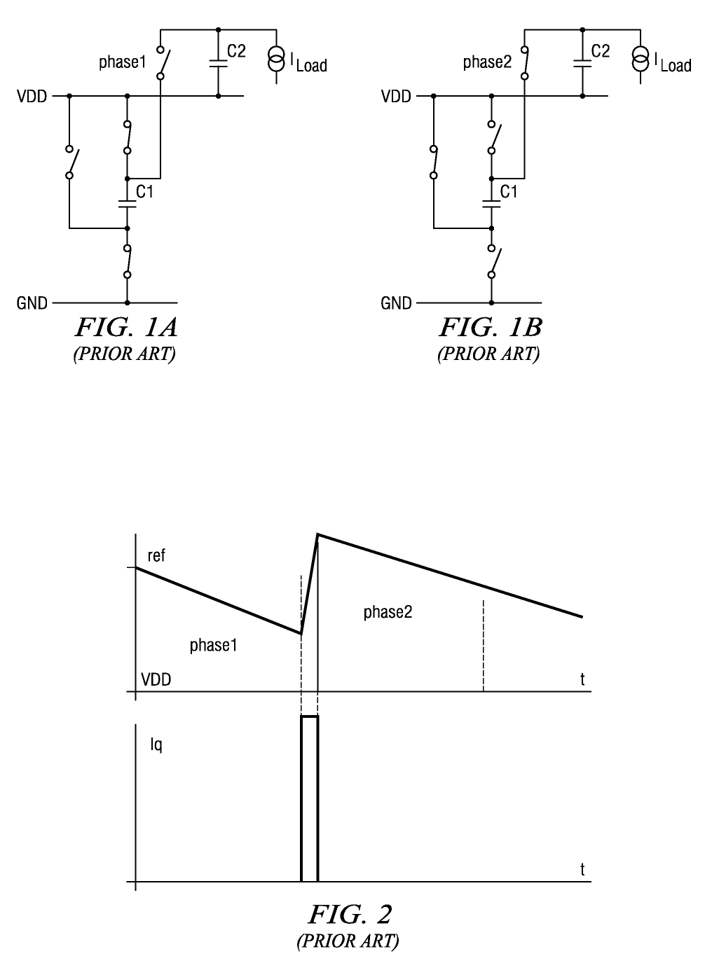

### DETAILED DESCRIPTION OF PREFERRED EMBODIMENTS

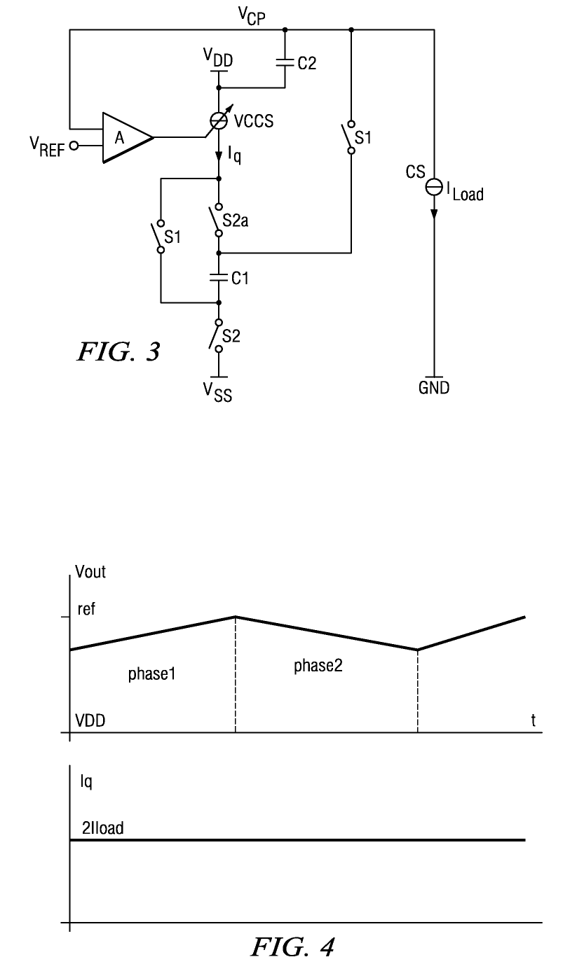

FIG. 3 is a simplified schematic diagram of a charge pump according to the present invention. Capacitor C1 is the flying capacitor which is alternately switched between either VDD and VSS, the ground potential, or between VDD and V_{CP} to charge storage capacitor C2. The output load is represented by a constant current source CS having a constant load current I_{Load}. The two switches S1 operate synchronously in alternation with switches S2 and S2a. The switching of S2a may be a bit different from S2 in order to avoid unwanted switching effects. During the first phase, switches S2 and S2a are closed and C1 is charged via VCCS. During the second phase S2 are S2a are opened and switches S1 are closed. In the second phase, flying capacitor C1 is coupled to storage capacitor C2 and discharges to C2. Both the charging and the discharging currents are controlled by current source VCCS. Accordingly, the voltage across C1 depends on the duration of the charging and discharging phases and the value of the current from current source VCCS. The amount of current supplied to capacitor C1 is defined by a feedback loop including error amplifier A and VCCS. A reference voltage V_{REF} and output voltage V_{CP} are both coupled to error amplifier A. Error amplifier A generates a control voltage in relation to the difference between reference voltage V_{REF} and output voltage V_{CP}. The control voltage is applied to a voltage controlled current source VCCS. Voltage controlled current source VCCS is controlled to supply a higher constant current to flying capacitor C1, if the voltage difference at the input of error amplifier A is large. A small voltage difference entails only a small control voltage and therefore a small current through VCCS. Error amplifier A and voltage controlled current source VCCS together determine the load on flying capacitor C1 and thereby output voltage V_{CP}. Generally the time constant of the control mechanism is greater than the switching frequency of switches S1, S2 and S2a. The current through VCCS remains substantially constant for a constant output current I_{Load}. For V_{ref} equal V_{CP}, the current Iq drawn from VCC is equal to two times I_{Load}.

FIG. 4 shows the output voltage of the charge pump in FIG. 3 versus time. This invention produces an output voltage ripple having a triangular form instead of the sawtooth form generated by conventional charge pumps. This triangular output voltage contains less high frequency components than a sawtooth output voltage and has half the amplitude. Therefore this invention generates less noise in following circuit units connected to the charge pump. FIG. 4 also shows the current Iq drawn from VDD by the charge pump of this invention. Current Iq is constant with no sharp peaks. Current Iq is equal to twice load current I_{Load} the current supply to the operational amplifier being driven by the charge pump. Therefore noise generated in the supply bus is considerably reduced.

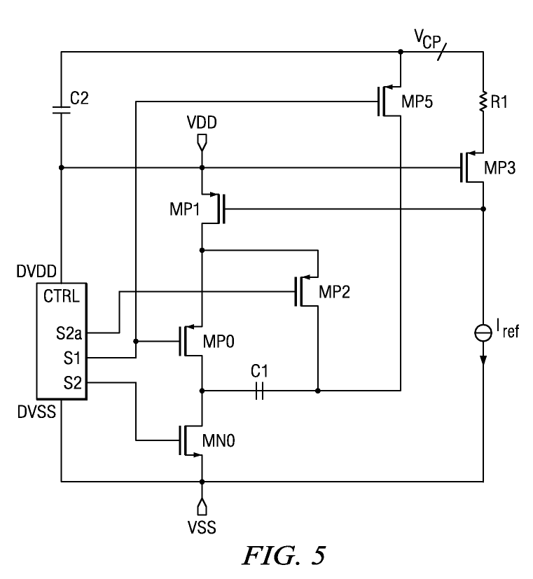

FIG. 5 shows a charge pump circuit according to a practical embodiment of the present invention. Controller CTRL may be an oscillator, a state machine or a microcontroller. Controller CTRL is connected between positive supply voltage VDD and negative supply voltage VSS. Controller CTRL includes output ports S1, S2 and S2a for controlling respective switches MP0 and MP5, MN0 and MP2 in the charge pump circuit. Controller CTRL uses a free running oscillator, the clock frequency or the voltage at the drain of MP1 as an indicator of the charge or discharge state of flying capacitor C1.

Flying capacitor C1 is connected to two switching paths implemented by MOS transistors. The first switching path is operable to connect flying capacitor C1 between positive supply voltage VDD and negative supply voltage VSS, which can be ground, via an NMOS transistor MN0 and a PMOS transistor MP2. Transistors MN0 and MN2 act as switches. The gate terminal of transistor MN0 is connected to port S2 of controller CTRL and the gate terminal of transistor MP2 is connected to port S2a of controller CTRL so that control ports S2 and S2a open and close the switches in the first switching path by applying appropriate gate voltages to transistors MN0 and MP2, respectively. It is also possible to use a single control port at controller CTRL to open and close the switching transistors MN0 and MP2.

The second switching path is operable to connect flying capacitor C1 between positive supply voltage VDD and charge pump voltage rail V_{CP} via two PMOS switching transistors MP0 and MP5. The gate terminals of both transistors MP0 and MP5 are connected to control port S1 of controller CTRL so that control port S1 opens and closes the switches in the second switching path by applying an appropriate gate voltage to both transistors MP0 and MP5.

A current source implemented by a PMOS transistor MP1 is connected between positive supply voltage rail VDD and flying capacitor C1 in both switching paths so that when the first switching path is open the current source MP1 is connected to a first terminal of flying capacitor C1 and when the second switching path is open the current source is connected to a second terminal of flying capacitor C1. The gate terminal of current source transistor MP1 represents voltage controlled current source VCCS shown in FIG. 3. The gate of MP1 is connected to a circuit that represents an error amplifier (as error amplifier A shown in FIG. 3). Error amplifier A and reference voltage generation circuit are embodied by transistor MP3, current source I_{ref} and resistor R1. In this case the reference voltage is the difference between the output voltage V_{CP} and VDD and is equal to V_{gs-MP3}+R1*I_{ref}. The gain is provided by transistor MP3, the reference current source I_{ref} and the drain terminal of PMOS transistor MP3, which is configured to act as an error amplifier. Therefore, the output voltage V_{CP} of the charge pump can be regulated as required by choosing appropriate values of R1 and I_{ref}.

Storage capacitor C2 stores the voltage that is to be applied to a load. Storage capacitor C2 is connected between charge pump voltage rail V_{CP} and positive supply voltage rail VDD.

In the first phase of operation, control ports S2 and S2a of controller CTRL close transistors MN0 and MP2 and control port S1 opens transistors MP0 and MP5. Current from current source transistor MP1 flows through flying capacitor C1 from positive supply voltage rail VDD via current source MP1 and closed transistor MP2 to negative supply voltage rail (ground) via closed transistor MN0. This current flow charges flying capacitor C1. In the second phase of operation, control port S2 and S2a open transistors MN0 and MP2 and control port S1 closes transistors MP0 and MP5. This means that the negative terminal of flying capacitor C1 is now connected to positive supply voltage rail VDD via current source MP1 and closed transistor MP0 and the positive terminal of flying capacitor C1 is connected to charge pump voltage rail V_{CP} via closed transistor MP5. Current from current source transistor MP1 then flows through flying capacitor C1 in the opposite direction to the direction of current flow through flying capacitor C1 during the first phase of operation. This discharges flying capacitor C1. As capacitor C1 discharges, it charges storage capacitor C2 to the required operational amplifier input voltage. When controller CTRL detects that charge pump voltage rail V_{CP} is at the required voltage, controller CTRL shuts off transistors MP0 and MP5 using control port S1 and opens transistors MN0 and MP2 using control ports S2 and S2a, respectively. The first phase of operation of the charge pump then begins again so that flying capacitor C1 performs a charge and discharge cycle and the charge pump operates continuously.

Although the present invention has been described with reference to a particular embodiment, it is not limited to this embodiment and no doubt further alternatives will occur to the skilled person that lie within the scope of the claimed invention.

What is claimed is:

1. A charge pump comprising:
a storage capacitor (C2) for storing a charge pump voltage; and
a flying capacitor (C1);
a current source (VCCS) having an input connected to a supply voltage and an output;
a switching means (S1, S2, S2a) configured to charge said flying capacitor (C1) during a first phase of operation from said current source (VCCS) and discharge said flying capacitor (C1) during a second phase of operation so as to charge said storage capacitor (C2), said switching means (S1, S2, S2a) switching current from current source (VCCS) through said flying capacitor (C1) in a first direction during said first phase and in a second direction opposite to said first direction during said second phase.

2. The charge pump according to claim 1, wherein:
said current source is a variable current source.

3. The charge pump according to claim 2, further comprising:
a control loop including an error amplifier adapted to compare an output voltage of said charge pump (V_{CP}) with a reference voltage (Vref), said error amplifier generating a control signal coupled to control said variable current source based on a difference between the output voltage of the charge pump (V_{CP}) and said reference voltage (Vref).

4. The charge pump according to claim 3, wherein:
a time constant of said control loop is substantially greater than a period of a switching sequence of said switching means (S1, S2, S2a).

5. The charge pump according to claim 1, further comprising:
a controller for controlling said switching means.

6. The charge pump according to claim 5, wherein:
said switching means comprises a first switching path for switching current through said flying capacitor (C1) in said first direction and a second switching path for switching current through said flying capacitor (C1) in said second direction, wherein said second switching path is controlled by a single control port in said controller.

7. A charge pump comprising:
a storage capacitor (C2) having a first terminal connected to a supply voltage (VDD) and a second terminal connected to a charge pump voltage (VCP);
a flying capacitor (C1) having a first terminal and a second terminal;
a first MOS transistor (MN0) of a first conductivity type (N) having a source connected to said first terminal of said flying capacitor (C1), a drain connected to ground (VSS) and a gate;
a second MOS transistor (MP0) of a second conductivity type (P) opposite to said first conductivity type (N) having a source, a drain connected to said first terminal of said flying capacitor (C1) and a gate;
a third MOS transistor (MP1) of said second conductivity type (P) having a source connected to said supply voltage, a drain connected to said source of said second MOS transistor and a gate;
a fourth MOS transistor (MP2) of said second conductivity type having a source connected to said drain of said second MOS transistor, a drain connected to said second terminal of said flying capacitor and a gate;
a resistor (R1) having a first terminal connected to said charge pump voltage (V_{CP}) and a second terminal;
a fifth MOS transistor (MP3) of said second conductivity type (P) having a source connected to said second terminal fo said resistor (R1), a drain connected to a first terminal of a load (I_{ref}) and a gate connected to said supply voltage (VDD);
a sixth MOS transistor (MP5) of said second conductivity type (P) having a source connected to said supply voltage (VDD), a drain connected to said source of said third MOS transistor (MP2) and a gate connected to said drain of said fifth MOS transistor (MP3); and
a controller (CTRL) having a first output (S1) connected to said gate of said second MOS transistor and said gate of said sixth MOS transistor (MP5), a second output (S2) connected to said gate of said first MOS transistor (MN0) and a third output (S2a) connected to said gate of said fourth MOS transistor (MP2); and
wherein said controller (CTRL) operating a sequence consisting of a first phase (phase1) followed by a second phase (phase2), said controller (CTRL) operating during
the first phase (phase1) whereby said first output (S1) causes said second MOS transistor (MP0) and said sixth MOS transistor (MP5) to be turned OFF, said second output (S2) causes said first MOS transistor (MN0) to conduct and said third output (S2a) causes said fourth MOS transistor (MP2) to conduct, and
the second phase (phase2) whereby said first output (S1) causes said second MOS transistor (MP0) and said sixth MOS transistor (MP5) to conduct, said second output (S2) causes said first MOS transistor (MN0) to be turned OFF, and said third output (S2a) causes said fourth MOS transistor (MP2) to be turned OFF.

8. The charge pump according to claim 7, wherein:
said first conductivity type is N type (N); and
said second conductivity type is P type (P).

9. A method of providing an input voltage to an operational amplifier comprising the steps of:
providing a storage capacitor for storing the input voltage;
charging a flying capacitor during a first phase of operation;
discharging the flying capacitor during a second phase of operation;
charging the storage capacitor during the second phase of operation using current produced from discharging the flying capacitor; and
switching current from a current source through the flying capacitor in a first direction during said first phase and in a second direction opposite to the first direction during said second phase.
